(19) United States
(12) Patent Application Publication
(10) Pub. No.: US 2017/0165711 A1
(43) Pub. Date: Jun. 15, 2017

(54) METHOD FOR THE MICRO-STRUCTURED APPLICATION OF A FLUID OR PASTE ONTO A SURFACE

(71) Applicant: Robert Bosch GmbH, Stuttgart (DE)

(72) Inventors: Heribert Weber, Nuertingen (DE); Michael Knauss, Pfullingen (DE)

(21) Appl. No.: 15/368,222

(22) Filed: Dec. 2, 2016

(30) Foreign Application Priority Data
Dec. 11, 2015 (DE) 102015224992.1

(51) Int. Cl. B05D 1/32; B05D 5/08; B05D 3/06

(52) U.S. Cl. CPC B05D 1/322; B05D 3/06; B05D 5/08

(57) ABSTRACT

A method for the micro-structured application of a fluid or paste onto a surface, including providing a substrate having a surface, coating the surface with a non-stick layer, at least partially removing the non-stick layer and producing a coating area, and applying at least one fluid droplet or paste droplet onto the surface in the coating area.

### CROSS REFERENCE

The present application claims the benefit under 35 U.S.C. §119 of German Patent Application No. DE 102015224992.1 file on Dec. 11, 2015, which is expressly incorporated herein by reference in its entirety.

### FIELD

The present invention relates to a method for the micro-structured application of a fluid or paste onto a surface.

### BACKGROUND INFORMATION

Various methods that make it possible to deposit material on a surface in a defined manner are commercially available. Among them, for example, are methods such as time-pressure dispensing, the ink-jet method or the aerosol-jet method. In these methods, material in the form of pastes or inks is deposited onto a surface. The methods essentially differ by whether the paste/ink is pressed out of a hollow needle and the droplet is then deposited on a surface by contact with this surface (time-pressure dispensing) or whether a paste-ink droplet is “shot” through a needle or nozzle onto the surface (ink jet or aerosol-jet method).

When depositing on surfaces, uncontrollable spreading (expanding of the droplets at the surface) of these pastes or inks generally occurs, which is primarily dependent upon the wetting of the material and the surface (contact angle) and additionally, on the droplet volume, and thus the droplet size, and also on the composition of the paste/ink (employed solvent etc.).

### SUMMARY

It is An object of the present invention to avoid uncontrollable spreading in methods that apply material in the form of pastes or inks onto a surface, and to ensure a defined deposition. Furthermore, depositions in which material is deposited in an area whose diameter may be considerably smaller than the diameter of the deposited paste or ink droplet are to be possible.

The present invention relates to a method for the micro-structured application of a fluid or paste onto a surface. In accordance with the present invention, suitable non-stick layers are used that are applied onto the surface to be coated and thereby prevent wetting of the surface. However, in order to nonetheless allow controlled coating of only defined areas by the material to be deposited, the non-stick layer is removed in the areas to be coated, using laser structuring. The removal of very small areas of the non-stick layer advantageously allows for the creation of very small coating areas. In an advantageous manner, this makes it possible to coat areas of the surface that are very small, in particular smaller than the minimum diameter of a fluid droplet or a paste droplet that is applied for the coating.

One advantageous further refinement of the method of the present invention provides for the removal of the non-stick layer with the aid of laser radiation. This advantageously makes it possible to create an especially small coating area or one that is structured in an especially precise manner.

One advantageous further refinement of the method of the present invention provides that after the fluid or paste has been applied, a solvent is expelled from the paste droplet or ink droplet. This advantageously creates a permanent coating.

One advantageous further refinement of the method of the present invention provides that the non-stick layer is subsequently removed. This advantageously creates a clean surface once the non-stick layer has performed its function.

The example method described herein may be used not only as hereinafter described in the specifically elucidated case, but can basically be employed wherever spreading of the applied material on the substrate is to be controlled when using the conventional dispensing method (conventional or jet method) or using screen printing or stencil printing, in order to thereby obtain finer and more precisely defined structures.

A specific application description using the function layer of a gas sensor as an example:

In the production of gas sensors, the problem is currently encountered that the droplet sizes able to be produced in a defined manner by the afore-described methods lead to coating areas that are too large. The goal is to be able to produce dot sizes on surfaces of −50 μm and smaller in high volume. At present, only dot sizes of 100 μm and larger are implementable in a reliably manageable manner. There are generally two reasons for the currently achievable dot sizes. First of all, there is the minimally to be generated droplet volume, and secondly, the spreading of the paste droplet on the wafer surface. Both properties are often directly linked inasmuch as the afore-described methods are able to process only pastes/inks that possess certain properties, for instance with regard to their viscosity or the thixotropy.

### BRIEF DESCRIPTION OF THE DRAWINGS

FIG. 1a shows a paste droplet before it impinges upon a surface in a method for the micro-structured application in the related art.

FIG. 1b shows a paste droplet after impinging upon a surface in a method for the micro-structured application in the related art.

FIGS. 2a-d show in an exemplary embodiment how the production of a paste dot may be carried out with the aid of a non-stick layer in a method for the micro-structured application according to the present invention.

FIG. 2a shows a paste droplet or ink droplet after it has been deposited on the wafer surface in a coating area without a non-stick layer.

FIG. 2b shows the behavior of a paste droplet or ink droplet while a solvent is expelled from the fluid.

FIG. 2c shows a paste dot produced according to the present invention.

FIG. 2d schematically shows a device produced by the method of the present invention, in which the non-stick layer was removed as well.

FIG. 3 schematically shows an example method according to the present invention for the micro-structured application of a fluid or paste onto a surface.

### DETAILED DESCRIPTION OF EXAMPLE EMBODIMENTS

The present invention now describes a possibility of using an applied and structured non-stick layer to produce dot sizes that are smaller than those that could normally be produced by the methods mentioned in the related art, since the applied droplet volume is able to wet only the opened area within the non-stick layer, and spreading is thereby effectively prevented.

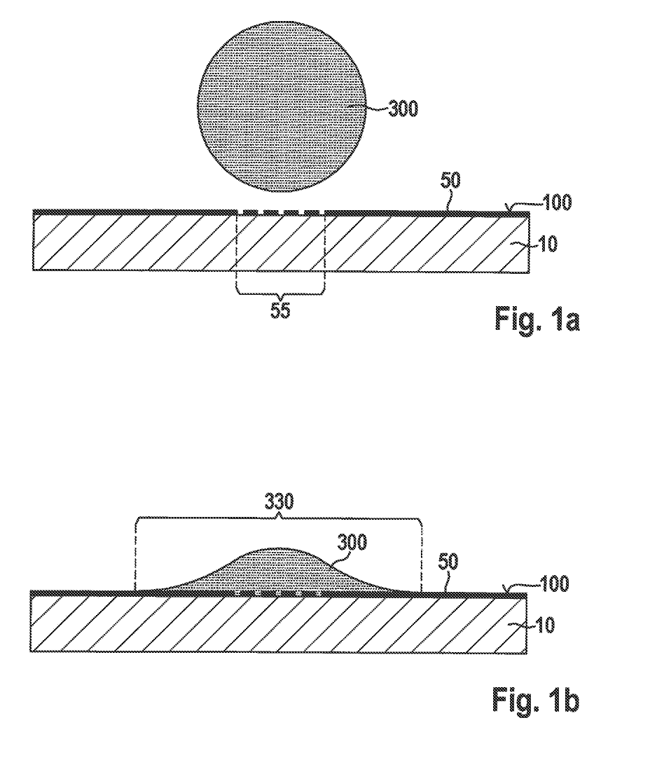

FIG. 1a shows a paste droplet before it impinges upon a surface in a method for the micro-structured application in the related art. Paste droplet 300 is situated above surface 100 of a substrate 10, which is a semiconductor substrate in the form of a semiconductor wafer in this particular case. Substrate 10 is provided with an additional structured layer 50, whose freely accessible surface also forms surface 100. In the exemplary embodiment shown, structured layer 50 includes an interdigital structure 55 of a micromechanical gas sensor, onto which paste droplet 300 is applied.

FIG. 1b shows a paste droplet after imping upon a surface in a method for the micro-structured application in the related art. Droplet 300 is shown after impinging upon surface 100. It is clear that spreading 330 of the droplet occurs at the wafer surface. Defined spreading of the droplet at the wafer surface is desired as a rule because it leads to better adhesion of the droplet to the surface. Unfortunately, spreading 330 of droplet 300 also has the effect that it negatively impacts the heat conduction of a diaphragm providing excellent thermal insulation, for instance. In addition, the restriction of spreading 330 of droplet 300 is absolutely mandatory if the structures produced in this way are to be miniaturized further, or if different substances that must not run into one another are to be applied next to one another.

In micromechanical gas sensors, the gas conversion usually takes place with the aid of paste dots on interdigital structures, which are able to be heated in a defined manner and evaluated resistively. The detection of certain gases or also gas mixtures, or the sensitivity of the gases to be detected with the aid of the paste dot, is dependent upon the temperature of the paste dot, among others things. In order to keep the power consumption of the gas sensors to a minimum, diaphragms featuring excellent thermal insulation are therefore employed, where the paste dot is situated on an interdigital structure that is disposed above a heater in an electrically insulated manner. Undefined spreading of a paste dot thus leads to undefined heat conduction of the diaphragm, so that the power consumption rises and a greater temperature gradient may be produced. The latter in turn causes a decrease in the precision of the gas measurement because gases or gas mixtures that lead to a signal rise at different temperatures, are now increasingly detected in parallel.

In the case of multi-dot sensors, spreading of paste droplets or ink droplets may cause different adjacently applied paste/ink droplets to run into one another and to thereby negatively influence the gas sensitivities of one another. In this case, the individual paste points would then have to be placed at a greater distance from one another, which would mean larger diaphragms and larger chips.

In order to avoid the afore-described effects, a non-stick layer 200, which is able to prevent spreading of paste droplet or ink droplet 300, is now employed according to the present invention.

To then produce coating areas locally where paste/ink droplets may adhere to surface 100, non-stick layer 200 is locally removed with the aid of laser radiation. Using well-focused lasers makes it certainly possible to realize exposure areas of −20 μm in diameter. The removal of non-stick layer 200 creates a coating area 250.

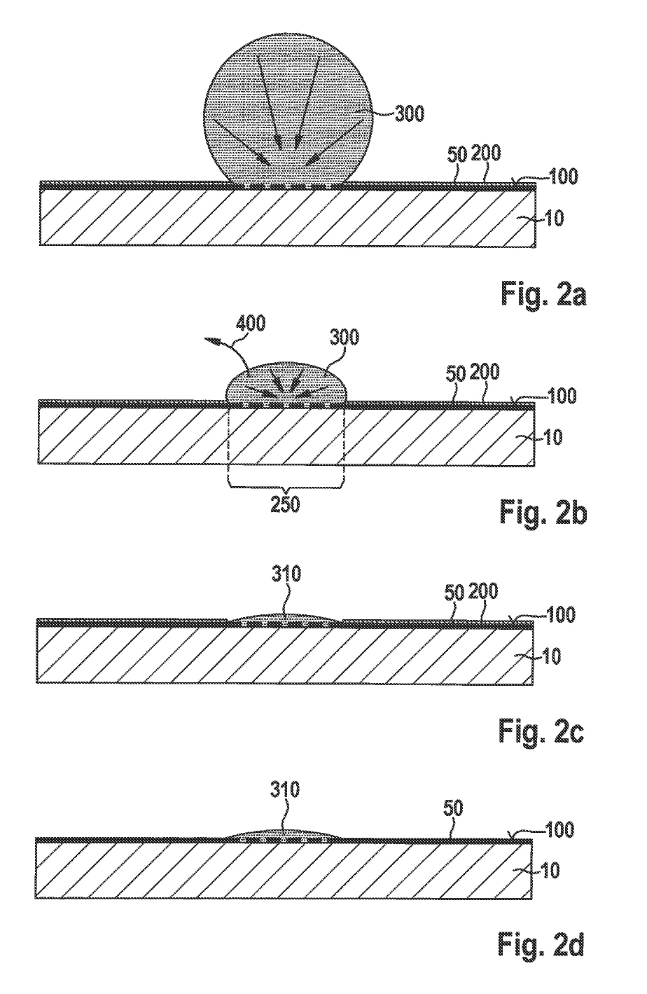

FIGS. 2a-d show in an exemplary embodiment how the production of a paste dot with the aid of a non-stick layer may be carried out according to the present invention.

FIG. 2a shows a paste/ink droplet 300 after it has been deposited on wafer surface 100 in a coating area 250 free of the non-stick layer. Because of the use of non-stick layer 200, droplet 300 is now no longer able to spread and sits in the form of a ball above the coating area 250 free of the non-stick layer. Even if droplet 300 has a much larger diameter than coating area 250 without the non-stick layer, it can wet only this area within the non-stick layer. This makes it possible to achieve a decoupling of the droplet diameter from the resulting diameter of the later paste dot.

FIG. 2b shows the behavior of a paste droplet or ink droplet while a solvent is expelled from the fluid. It is illustrated schematically how droplet 300 changes in comparison to FIG. 2a when solvent 400 is expelled from paste/ink droplet 300. Solvent 400 should be able to be expelled at a temperature that lies below a limit temperature, above which non-stick layer 200 would be destroyed.

FIG. 2c shows a paste dot produced according to the present invention. The figure schematically shows the state when all solvent has been expelled and only the gas-sensitive material for the gas conversion is still situated within the area without non-stick layer. In this state, this is now called a paste dot 310. The use of a structured non-stick layer 200 ultimately has led to the creation of a defined area in which gas-sensitive material is able to be deposited. This defined area essentially corresponds to coating area 250. Furthermore, the diameter of the defined area may be smaller than the diameter of original paste/ink droplet 300. To that extent, there is the possibility of producing smaller paste dots 310 with the aid of non-stick layer 200 than when using one of the aforementioned methods from the related art.

When selecting non-stick layer 200, it should be ensured that it is compatible with solvent 400 of paste/ink droplet 300. In other words, the solvent must want to form a wetting angle on the non-stick layer that is as large as possible. Since spreading 330 of a paste/ink droplet on a surface is able to be laterally restricted with the aid of the non-stick layer, there is now also the possibility of influencing the height of the resulting paste dot in that the ratio between solvent and gas-sensitive material in a paste/ink droplet can be selected more freely. A large solvent component leads to flat paste dots, and a low solvent component leads to higher paste dots. At a given diameter, it is thereby possible to utilize a further, influenceable parameter for producing a specific gas sensitivity, that is to say, the height or the volume of a paste dot.

FIG. 2d schematically shows a device that was produced by the method of the present invention, in which the non-stick layer was removed as well. In order to be able to achieve the maximum gas sensitivity of a paste dot 310, it is sintered at higher temperatures. Temperatures above 400° C. and also different gas atmospheres may be used in the process. If used non-stick layer 200 is an organic material, for example, then it is normally removed in an oxygen atmosphere at higher temperatures and thus no longer has an influence on the thermal conductivity of the diaphragm, for example.

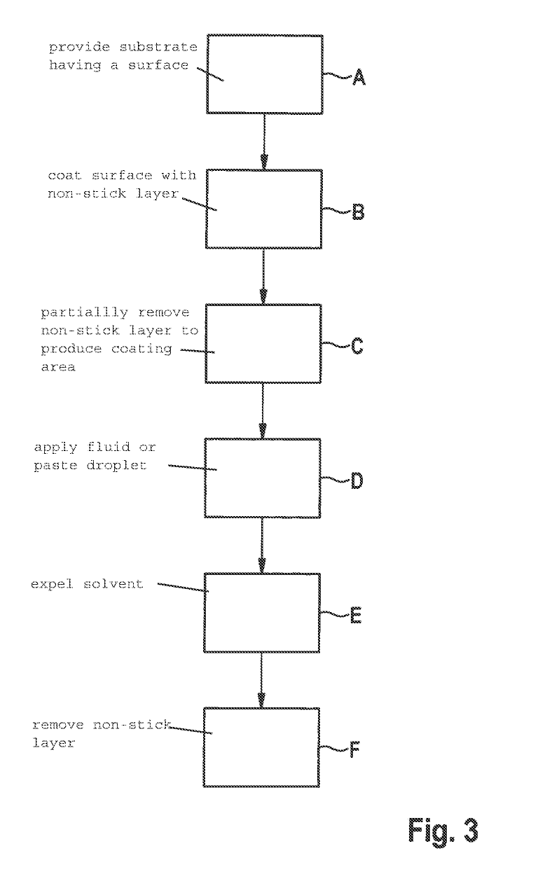

FIG. 3 schematically shows the method of the present invention for the micro-structured application of a fluid or paste onto a surface. The method includes the steps:
(A) Providing a substrate 10 having a surface 100,
(B) Coating surface 100 with a non-stick layer 200,
(C) At least partially removing non-stick layer 200 and producing a coating area 250, and
(D) Applying at least one fluid droplet or paste droplet 300 onto surface 100 in coating area 250.

The non-stick layer is deposited in step (B) from the gas phase. The layer thickness lies in the range of a few monolayers. It is self-limiting.

In addition, it is possible to expel a solvent 400 from the paste droplet or ink droplet 300 in a step E which follows step D. Solvent 400 should be expelled at a temperature that lies below a limit temperature, above which non-stick layer 200 would be destroyed. The solvent is usually expelled into the air. However, as an alternative, the expelling of the solvent in another atmosphere such as O2, N2, inertial gas, forming gas or other gases or gas mixtures, for instance, is also possible.

In addition, it is possible to remove non-stick layer 200 in a step F which follows step E.

In an alternative development of the method of the present invention, a photoresist mask, rather than a non-stick layer, is employed in step (B). The photoresist is applied by spin-coating and thus deposited in a considerably thicker layer than the non-stick layer applied in the aforementioned deposition method. In step (F), the photoresist can therefore be removed without residue only by a plasma ashing step. However, this produces gas radicals that may react with the paste dot and have a negative effect on the gas sensor function.

As an alternative, the photoresist is able to be removed at a higher temperature in O2 or in situ during sintering, as may be the case with the non-stick layer. However, the resist would combust in the process and leave carbon-containing residue on the surface which may adversely affect the sensor function. A wet-chemical removal of the photoresist is also possible, but the generally known solvents affect the gas-sensor function in an adverse manner too.

To this extent, a resist mask may be an alternative to non-stick layer 200 but not in those instances where the restriction of coating area 250 of gas-sensitive paste dots, in particular for gas sensors, is involved.

### LIST OF REFERENCE NUMERALS

10 substrate

50 structured layer

50 interdigital structure

100 substrate surface

200 non-stick layer

250 coating area

300 fluid droplet/paste droplet

310 paste dot

330 spreading

400 solvent

What is claimed is:

1. A method for the micro-structured application of a fluid or paste onto a surface, comprising:
(A) providing a substrate having a surface;
(B) coating the surface with a non-stick layer;
(C) at least partially removing the non-stick layer and producing a coating area;
(D) applying at least one fluid droplet or paste droplet onto the surface in the coating area.

2. The method as recited in claim 1, wherein the removal of the non-stick layer is carried out in step (C) with the aid of laser radiation.

3. The method as recited in claim 1, wherein following step (D), a solvent is expelled from the paste droplet or the ink droplet in a step (E).

4. The method as recited in claim 3, wherein the non-stick layer is removed after step (E) in a step (F).
